(19) United States
(12) Patent Application Publication
(10) Pub. No.: US 2021/0090457 A1
(43) Pub. Date: Mar. 25, 2021

(54) TATTOO PRACTICING AID

(71) Applicant: Richard Cody Deegan, Fallon, NV (US)

(72) Inventor: Richard Cody Deegan, Fallon, NV (US)

(21) Appl. No.: 17/115,497

(22) Filed: Dec. 8, 2020

Related U.S. Application Data
(60) Provisional application No. 63/078,100, filed on Sep. 14, 2020.

(51) Int. Cl. G09B 11/00; G09B 19/00; G06F 3/0354; G06T 11/00; G06F 3/0487

(52) U.S. Cl. CPC G09B 11/00; G09B 19/00; G06F 3/0487; G06T 11/001; G06F 3/03545

(57) ABSTRACT

Disclosed is a system and method that simulates making a tattoo on the skin using a needle-based tattooing machine. The system includes an electronic device and a stylus. The electronic device includes a processor, a memory, and a display. The display can include a touchscreen and preferably the display can differentiate between different levels of pressure/force applied on its surface. An interface can be presented on the display that includes a canvas window and a menu. The menu can include options for the type of tattooing needles and voltage. A pattern can be drawn with strokes of the stylus on the canvas window, wherein the pattern resembles needle marks on skin made by a tattooing machine.

### CROSS-REFERENCE TO RELATED APPLICATIONS

This application claims priority to a U.S. provisional patent application Ser. No. 63/078,100, filed on Sep. 13, 2020, which is incorporated herein by reference in its entirety.

### FIELD OF INVENTION

The present invention relates to a system and method for practicing tattoo making, and more particularly, the present invention relates to a system and method that simulates the needle-based tattooing machine for practicing the craft of tattooing.

### BACKGROUND

A tattoo is a graphical impression that is made by injecting pigments into the dermis layer of the skin. The art of making a tattoo is generally known as tattooing, and a person who makes the tattoo is called a tattoo artist. The most common way of tattooing is using a handheld machine known as a tattooing machine. The handheld machine includes one or multiple reciprocating needles that penetrate the dermis layer of the skin for rapidly injecting the pigments forming the desired pattern. Only skilled hands can operate the tattooing machine efficiently to get the desired pattern. For example, if the penetration is too deep in the skin, the design may not be easily visible through the surface or may look blurred. On the other hand, if the injection is too superficial, the ink may migrate to produce a blurred image or be gradually removed to produce a faded image as the dermis is recycled.

Like any other graphic designing, a tattoo artist also learns their craft via an apprenticeship under a skilled and experienced mentor. The learner generally practices tattooing on a skin model. Typically, the skin models are synthetic sheets made of materials, such as rubber that can be penetrated by a needle replicating a natural skin. However, the available skin models for practicing tattooing are far from the actual skin. The results of practicing on a skin model do not replicate even close on natural skin. The learners are unable to judge how the design will appear on the natural skin. Thus, a need is appreciated for a practicing model for tattoo artists. A need is appreciated for a practicing model that simulates the tattooing on natural skin. A need is appreciated for a practicing model that allows tattooing artists to enhance and sharpen their skills.

### SUMMARY OF THE INVENTION

The principal object of the present invention is therefore directed to a system and method for practicing tattooing.

It is another object of the present invention that the system simulates tattooing on natural skin.

It is still another object of the present invention that the system and method are economical in their application.

It is a further object of the present invention that the system and method do not generate waste.

It is still a further object of the present invention that the system and method allow practicing shading and blending techniques in tattooing.

It is yet another object of the present invention that the system simulates the effects of needle penetrations into the skin at a high speed.

It is an additional object of the present invention that the system and method allow Judging an apprentice's readiness without the mess and cost of supplies.

In one aspect, disclosed is a system and method that simulates a needle-based tattooing machine tattooing on a skin. The system includes an electronic device and a stylus. The electronic device includes a processor, a memory, and a display. The display has a touchscreen and preferably can also differentiate between different levels of pressure/force applied to its surface. The stylus includes an electrode at one end, wherein the stylus can be a pressure-sensitive stylus.

In one aspect, the computer-readable storage medium includes a set of instructions which when executed by the processor provides an interface, wherein the interface is presented on the display of the electronic device. The interface includes a canvas window and a set of options including the available grade and size of needles, voltage setting, damage toggle, force sensitivity, and other functions available in a tattooing machine. The different features of the disclosed system, such as the needles and voltage selection simulate the functionality of a needle-based tattooing machine. The canvas window can receive input from the stylus, and in response displays a pattern on an area getting in contact with the stylus. The pattern can be similar to a pattern drawn by the needles of the tattooing machine on the skin. The number of needle marks in the pattern can vary based on the selection of needle, voltage setting, and hand speed. In one case, the number of needle marks may vary from 33 to 200 times per second. The stylus can be moved on the touchscreen, like a tattoo machine on the skin, to draw a continuous pattern, where the marks per unit area depend on the speed of the hand.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing an exemplary embodiment of the system, according to the present invention.

FIG. 2 shows an exemplary embodiment of the system, according to the present invention.

FIG. 3 shows an exemplary embodiment of the disclosed interface including the canvas window and a menu, according to the present invention.

FIG. 4 shows another embodiment of the disclosed interface, according to the present invention.

FIG. 5A shows continuous needle marks pattern drawn by a continuous stroke of the stylus on a display of the electronic device, according to an exemplary embodiment of the present invention.

FIG. 5B shows a different pattern drawn by the stylus, according to an exemplary embodiment of the present invention.

FIG. 5C shows the overworked areas on the drawn pattern highlighted as spots, according to an exemplary embodiment of the present invention.

FIG. 6A shows the pattern rendered at the voltage setting of 5V that is equivalent to a tattooing needle frequency of 33 cps, according to an exemplary embodiment of the present invention.

FIG. 6B shows the pattern rendered at the voltage setting of 9V that is equivalent to a tattooing needle frequency of 100 cps, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form to facilitate describing the subject innovation.

Disclosed is a system and method for practicing tattooing. The disclosed system simulates the tattooing on the skin using a needle-based tattooing machine, such that an artist can learn the craft using the disclosed system. The disclosed system embodies most of the features of tattoo crafting so that a tattoo drawn on the system could be replicated on the skin using the tattooing machine. The tattoo machine can be a portable handheld tattooing machine that has multiple reciprocating needles that inject the ink up to the dermis layer of the skin. Perhaps the reciprocating needles simultaneously make several punctures in the dermis layer of skin and the ink held by needles is drawn down into the punctures resulting in a pattern, referred to herein as needle marks. The tattooing machine generally has different grades and types of the needle which can be used for different purposes. For example, liner needles can be used for outlining, while magnum needles can be used for shading and coloring. Multiple needles can be used that simultaneously works to speed up the process. For outlining in a tattoo, generally, 3 to 9 round needles can be used. While for shading and coloring, 9 to 25 needles can be used. The needle marks made per unit area by a tattooing machine can depend upon the type and number of needles used for making the pattern, hand speed, and the voltage setting on the tattooing machine. The disclosed system and method simulates the tattooing machine for making needle marks on an interface provided by the system. The voltage setting affects the frequency of the needles, the frequency provided herein in the cycles per second (CPS).

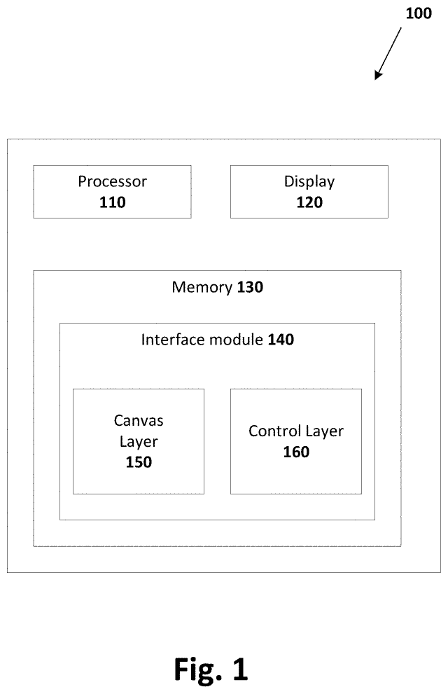

Referring to FIG. 1, the disclosed system 100 can be an electronic device having processor 110, a display 120, and a computer-readable storage medium 130. The electronic device can be a smartphone or a tablet computer. The electronic device can have an enlarged display, such as 5-15 inches in diagonal length. Preferably, the display can include a touchscreen that can receive a touch input. Different types of touchscreen technologies are known to a skilled person, for example, resistive and capacitive touchscreen technologies are commercially available for use in touch enable electronic devices. Preferably, the disclosed system can have a display that can differentiate between various levels of force exerted by a stylus on its surface. For example, known are the touchscreens based on Force-Touch technology developed by Apple in 2015. The Force-Touch technology, also known as “3D touch” on iPhones, the said technology enables the touch screen to distinguish between various levels of force applied to their surfaces. For example, iPad Pro by Apple is a touchscreen-enabled tablet computing device that uses the 3D touch technology. It is to be understood that all types of known and futuristic touchscreen technologies are within the scope of the present invention. It is, however, a preferred embodiment that the touchscreen can distinguish between various levels of force applied to its surface. The electronic device can also include an operating system. For example, some of the commercial operating systems for use in smartphones and tablet computers include iOS by Apple, Windows by Microsoft, and Android by Google.

The disclosed system can also include a stylus. A touchscreen can generally be operated by a finger or stylus. The stylus is of an elongated pen-like configuration that can be held in a hand, like a pen while writing. At least one tip of the stylus can have an electrode that can touch the touchscreen for providing input. It is preferable, that the stylus is a pressure-sensitive stylus that can differentiate between different levels of forces. Moreover, the stylus could determine the direction of its movement and its angle relative to the touchscreen surface. It is to be understood that a commercial stylus can be used without departing from the scope of the present invention. For example, Pencil from Apple is a commercial stylus that can be used with iPad Pro tablet computers. The Pencil by Apple can measure the pressure differences, altitude, and azimuth. The altitude and azimuth properties can be used to detect the direction of movement of the stylus.

In one embodiment, the computer-readable storage medium 130 can include a set of instructions which, when executed by the processor 110 causes the processor to perform one or more steps of the disclosed process. The computer-readable storage medium 130 can include an interface module 140. The interface module can be provided as application software that can be installed on the electronic device. The application software can be developed for Android, iOS, windows, and any other known operating platform for mobile devices or desktop computers. The application software can be made available through a distribution service provider, for example, Google Play operated and developed by Google and the app store by Apple. In addition to the application software, a website-based interface can also be provided through the world-wide-web.

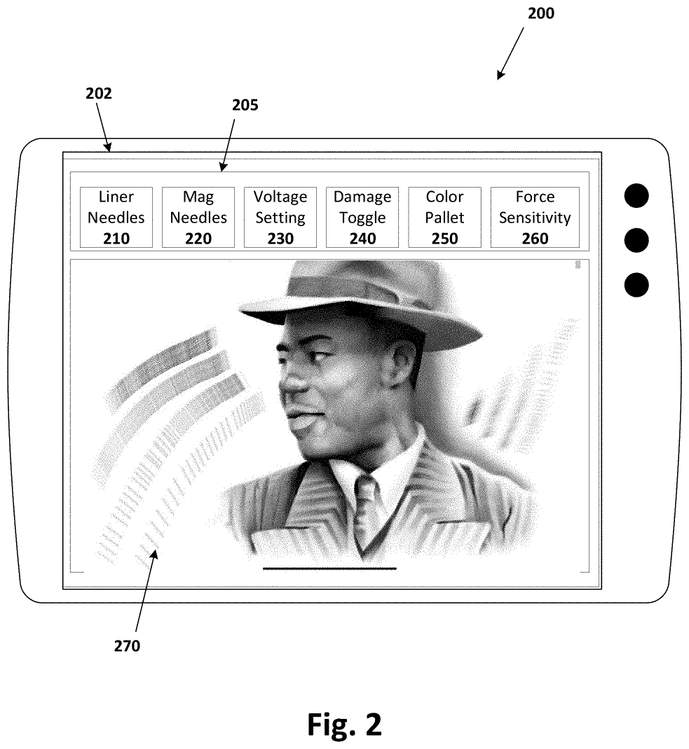

Broadly, the interface module can include a canvas layer 150 and a control layer 160. The canvas layer on execution by the processor can present at least one canvas window on the display of the touchscreen display of the disclosed system. The canvas layer can receive a touch input from the stylus on the canvas window and in response, the canvas layer can create or manipulate a pattern on an area of the canvas window in contact with the stylus. In one case, strokes are made by the stylus by dragging it on the touchscreen to form a continuous pattern similar to a tattooing machine forming a continuous pattern on the skin. The canvas layer can receive one or more variables from the touch screen and the stylus, for example, the variables can include force exerted by the stylus on the display, and altitude and azimuth of the stylus respective to the touchscreen surface. An embodiment of the canvas window is shown in FIG. 2.

FIG. 2 shows an exemplary embodiment of the system 200 having the display 202 that can be similar to a display of the tablet computing device. The canvas window 270 is presented on the display wherein a user through a stylus can draw a pattern on the canvas window. FIG. 2 shows several patterns including pattern drawn with strokes of different needle types and a tattoo pattern resembling a human avatar. As can be seen in FIG. 2 that the pattern resembles needle marks made by needles of a tattooing machine on a surface, such as the skin. In case, the canvas window can include multiple stacked layers, wherein each layer can be manipulated independently from other layers. Moreover, the transparency of each layer can also be adjusted. A specific layer from the multiple layers can be toggled and worked-on. Perhaps, the canvas window can have one layer and additional layers can be added by the user. Additionally, one or more layers can also be deleted or made hidden by the user. The user can also hide all the layers and selectively activate one layer.

The control layer on execution by the processor can provide a menu that presents on the display. FIG. 2 shows menu 205 has a set of options. The menu can present as a bar or a ribbon. The menu shown in FIG. 2 resembles a ribbon configuration, wherein the options are visible on the ribbon. The control layer can receive one or more selections of the options from a user through the menu. The options can be displayed as clickable buttons, wherein the user clicks the button to select the option. The options can be presented as a drop-down list, or icons, or both. Moreover, the menu can also receive a value for an option from the user.

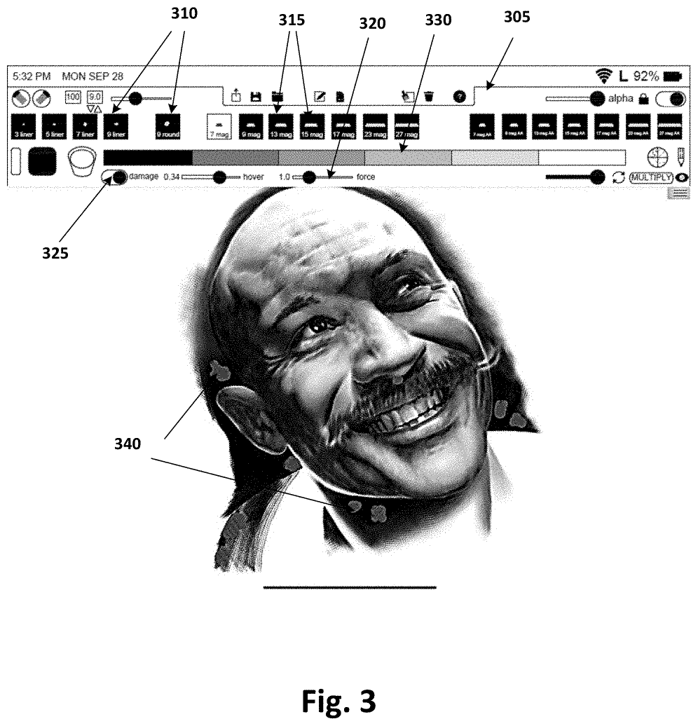

FIG. 2 shows menu 205 of the disclosed interface having the set of options. FIG. 3 shows an exemplary embodiment of menu 305 configured as a ribbon. Menu 305 includes a set of options presented as icons, toggle bars, and sliders. Referring to FIGS. 2 and 3, the menu provided by the disclosed control layer can include options of the type of needles, including the liner needles 210 and Mag needles 220. A user can pick a desired type of needle from the menu. The drawn pattern from the action of the stylus on the canvas window corresponds to the selection of the needle type. For example, the outline of a tattoo can be drawn by selecting any of the Liner needles from the menu. The shading can be done using the Mag needles similar to the tattooing using a needle-based tattooing machine. The user can try the appearance of the needle marks, for different needle selections, by making strokes with the stylus in a margin area of the canvas window. For example, FIG. 2 shows the strokes 270 made with different needle types. The options for the type of needles can be presented as icons that can be activated by clicking the icon. A user can toggle between the needle type by clicking the icons. FIG. 3 shows the square icons of liner needles 310 and Mag needles 315. Each icon is shown to have the name of the needle and an illustration of the needle mark drawn by the needle. For example, the icon for 9 MAG needle includes the text “9 Mag” and a representation of stacked nine needle marks. The menu can have options for receiving a value of voltage 230, a damage toggle 240, a color palette 250, and options for specifying the force sensitivity 260. FIG. 3 shows the option of activating and deactivating damage as a toggle button 325 that can be activated and deactivated by a click. Color palette 330 represents the color as tiles. The force sensitivity option 320 is presented as a slider.

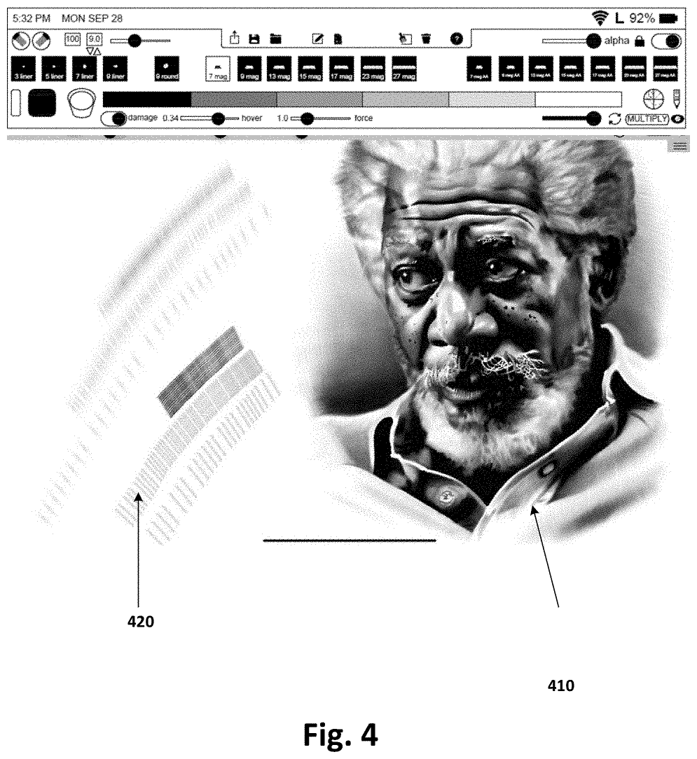

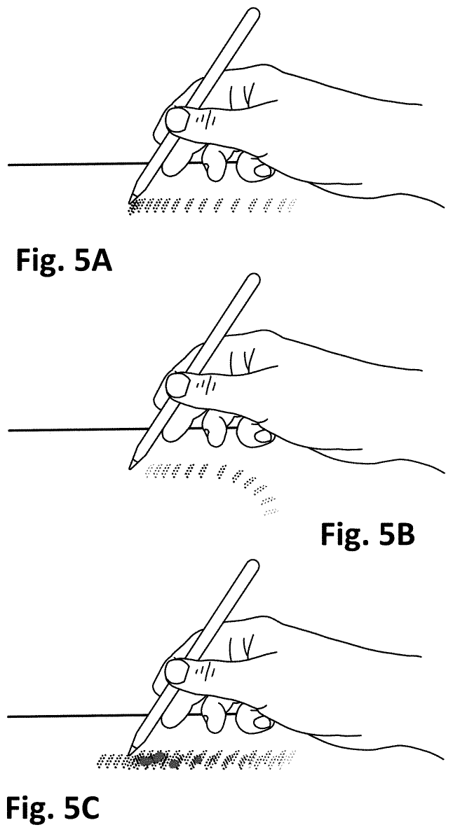

The stylus can be used to make strokes on the canvas window. Unlike, the brushes on the drawing apps, the stroke of the stylus results in needle marks pattern presented on the canvas window. The needle marks, including the spacings, corresponds to a pattern drawn by the reciprocating needles of the tattooing machine in the skin. FIG. 4 shows the different needle mark patterns, including the tattoo 410 and strokes 420, that can be drawn using different needle types presented in the menu. FIG. 5A shows a continuous single stroke made by a stylus on the disclosed canvas window. Also, FIG. 5A shows a needle mark pattern drawn on the canvas window, which resembles the successive needle marks produced by the reciprocating needles of a tattooing machine on the skin when the tattooing machine is dragged on the skin. FIG. 5B shows a different pattern that is curved. The stylus can be dragged on the touchscreen without stops to produce a continuous stroke. The pattern follows the touch of the stylus on the touchscreen, wherein the stylus is dragged from a first position to a second position on the canvas window, the pattern extends between the first position and the second portion. The pattern can be straight or curved. Moreover, the pattern can be uniform or varied depending upon the hand speed and, force & orientation of the stylus.

The type of needle for drawing the tattoo on the disclosed system can be selected from the menu. The options available on the menu are replicated from the types of commercial needles for tattooing. For example, liner needles 220 can be used for outlining, while the Magnum needles 240 can be used for shading and coloring. Each liner needles 220 and Magnum needles 240 can have a set of needle options, which is typically the grade and size of the needles. FIG. 3 shows four icons for four different types of liner needles that a user can select. The icon also shows the pattern made by the needle. Options include 3, 5, 7, and 9 needles i.e. an increment of two. One icon on the right of the liner needle having an option for round 9 needle. Moving further on the menu, on the right of the liner icons can be seen the options for magnum needles. The nine icons shown includes 7, 9, 13, 15, 17, 23, and 27 mag needle options. The pattern shown in FIG. 5a is drawn by a 9 Mag needle. It is to be understood that the options available for needle selection is not limited to the needle options shown in the Figures, but the needle options available on the menu replicate the commercially available needles for tattooing.

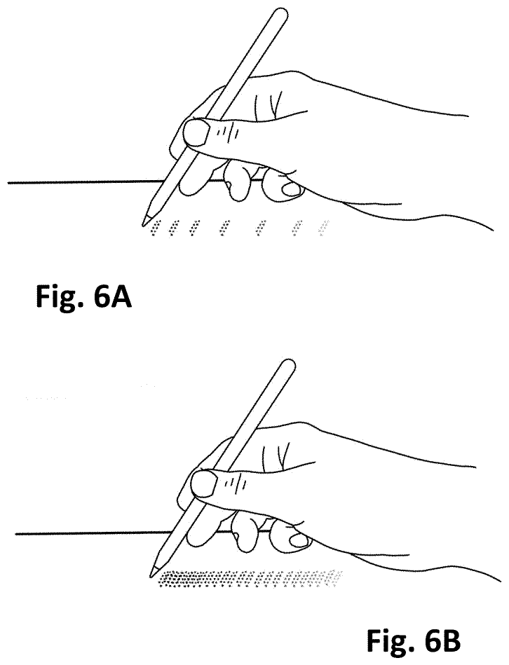

The voltage setting 230 can be used to specify the voltage. Herein, the voltage setting simulates the voltage setting on a tattooing machine that controls the amount of electricity supplied to the needles. The higher is the voltage, the more is the frequency of the reciprocating needles, and the more punctures the needles make. Changing the voltage setting on the disclosed system also affects the drawn pattern similar to the effect of changing the voltage on a tattooing machine on the skin. Perhaps, the system may allow a user to specify the make or specification of a tattooing machine, and based on the tattooing machine, the available options in the menu can correspond to the specifications of the tattooing machine. For example, needle options and voltage options available on the menu may correspond to the specification of the tattooing machine. FIG. 6A shows the pattern rendered at the voltage setting of 5V that is equivalent to a tattooing needle frequency of 33 cps. FIG. 6B shows the pattern rendered at the voltage setting of 9V that is equivalent to a tattooing needle frequency of 100 cps. Thus, an increase in the voltage increases the frequency of the needles, resulting in a condensed needle marks pattern.

The menu also having a feature for damage control shown by the element 240 “damage toggle” in FIG. 2. FIG. 3 shows this feature as a toggle button 325 to turn the damage feature on or off. Generally, while working on the skin, any area of the skin can be overworked, which can cause tissue injury. For example, overworking a skin area can cause injury to that area. The disclosed system can simulate the damage caused by a tattoo machine due to the overworking of an area of skin in a real situation. The value of a threshold, to the injury, can be determined by the system, wherein the threshold corresponds to different skin types and resistance of a skin type to needles. When the cumulated contact time of the stylus in contact with a unit area of the canvas window exceeds the predetermined threshold, the unit area can be highlighted. For example, FIG. 3 shows dark spots 340 on the pattern indicate the damage. These dark spots indicate that the highlighted area is overworked, and when the process is replicated on the skin, skin tissues can be injured. FIG. 5C also shows the spots indicating overworked areas on the pattern. The spots can be highlighted by a color, for example, red. Additionally, the system may allow a user to adjust the threshold. Moreover, in addition to the cumulated contact time of the stylus with the touchscreen, the force exerted by the stylus on the touchscreen can also be considered. An average of the force exerted, and the cumulative touch time can be used to determine a combined value that is compared with the predetermined threshold.

The menu can also include a color palette that may allow the selection of a color for the pattern. The available colors in the palette may correspond to the commercial pigments available for tattooing. The color palette allows a user to mix colors, creating new colors, like the real pigments. The color palette provides an ability to pick ink colors and dip between them to mix new. For example, the red color can be dipped in the yellow 4 or 5 times to get varying degrees of orange. To clear the selected color, a rinse option can also be provided on the color palette. The color selector has a black and gray version as well as a full-color version.

The menu as shown in FIG. 2 further has a force setting option 260 to specify the force sensitivity. The force setting can resemble the pressure applied to the needle or the pressure exerted by the needle on the skin. Typically, the more pressure applied on the needles causes deeper penetration of the needles in the skin, and thus the pigment is injected deeper into the skin. Deeper penetration of the needles may damage the skin tissues, while the pigments may not be visible on the surface. Superficial penetration may result in the pigments spreading to adjacent tissue, thus resulting in early fading of the tattoo. Thus, balanced pressure is essential for tattooing. The disclosed system allows a tattoo artist to learn applying the proper pressure by simulating the effects of the pressure on the needle. The control layer can allow manipulating the force sensitivity, wherein an option can be provided on the menu for setting the force sensitivity. FIG. 3 shows a slider 320 that can be moved right or left to increase or decrease the force sensitivity respectively.

Like tattooing on the skin, the selection of voltage, needle type, pressure, and hand speed, in the disclosed system, can affect the ink application. Artists can experiment with fast shading and slow saturation techniques. There is also corner shading that simulates using the corner of a magnum needle to taper a stroke in tight areas. Higher hand speed means more spacing between subsequent needle marks and lesser hand speed results in more needle penetration per unit area. The user can learn different aspects of tattooing including the hand speed, inclination of the machine, and like using the disclosed system. The disclosed system is perfect for the practice of blending, shading, and saturating techniques as well as developing an awareness of hand speed without injuring the skin tissue. A user can choose from different needle configurations including liners, rounds, magnums, and soft-edge magnums. Layout colors from the Eternal Ink lineup and dip between them to create new colors. Corner shade with various sized magnum needles.

In one embodiment, the disclosed system can allow a user to import a photo to use as a stencil guide. The stencil can be imported as a layer in the multilayer canvas window. The stencil layer can be stacked below the active tattoo layer and the transparency of the active layer can be increased. An option in the form of a slider can be provided to adjust the transparency of the active layer. Moreover, the stencil layer can be toggled on and off. Preferably, the photograph or stencil can be a line drawing on white background. Projects can be saved, and the artwork can be shared.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system that simulates tattooing on skin by a needle-based tattooing machine, the system comprising:
an electronic device having a processor, a memory, and a display, the display includes a touchscreen for receiving inputs from a stylus;
the memory including a set of instructions which, when executed by the processor causes the processor to:
provide an interface on the display, the interface comprises a canvas window and a menu, the menu comprises:
options of type of tattooing needles, and
options for setting a voltage,
receive, on the canvas window, an input from the stylus; and
upon receiving the input, create or manipulate a pattern on an area in contact with the stylus, the pattern corresponds to needle marks made by the needle-based tattooing machine on skin.

2. The system according to claim 1, wherein the display is configured to distinguish between various levels of force applied to its surface.

3. The system according to claim 2, wherein the processor further:
determine a force exerted by the stylus on the display, wherein the input of the stylus is a stroke made by the dragging of the stylus on the display, wherein the pattern is further based on the force.

4. The system according to claim 3, wherein the menu further:
includes an option to set a force sensitivity,
wherein the processor further:
receive a value of the force sensitivity, wherein the force is based on the force sensitivity.

5. The system according to claim 3, wherein the processor further:
receive an altitude of the stylus with respect to the surface of the display, wherein the pattern is further based on the altitude, wherein the effect of altitude on the pattern corresponds to an effect of tilt of the needle-based tattooing machine on the needle marks.

6. The system according to claim 1, wherein the processor further:
receive a value of voltage,
wherein the pattern is further based on the value of the voltage.

7. The system according to claim 1, wherein the menu further comprises:
options for color,
wherein the processor further:
receive a selection of color, wherein the pattern is further based on the selected color.

8. The system according to claim 7, wherein the processor further:
receive a selection and proportions of a plurality of colors from the color palette; and
mix the plurality of colors in the proportions.

9. The system according to claim 1, wherein the processor further:
determine a cumulative contact time and average force of the stylus on a unit area of the canvas window;
compare the cumulative contact time and the average force with a predetermined threshold; and
highlight the unit area based on the outcome of the comparison.

10. The system according to claim 1, wherein the processor further:
determine a cumulative contact time of the stylus, with a unit area of the canvas window;
compare the cumulative contact time with a predetermined threshold; and
highlight the unit area when the contact time is more than the predetermined threshold.

11. The system according to claim 10, wherein the processor further:
receive a value of the predetermined threshold.

12. The system according to claim 1, wherein the processor further:
receive a selection of a needle from the options of type of tattooing needles, wherein the pattern is based on the needle.

13. The system according to claim 12, wherein the needle is a liner needle, and the pattern is an outline of a tattoo.

14. The system according to claim 13, wherein the needle is a Mag needle, and the pattern is shading.

15. The system according to claim 1, wherein the input of the stylus is an elongated stroke made by dragging of the stylus on the canvas window, wherein the processor further:
determine the speed of the stylus while dragging, the speed of the stylus corresponds to a hand speed,
wherein the pattern is further based on the hand speed.

16. The system according to claim 15, wherein an increase in the hand speed widens a gap between adjacent needle marks, while a decrease in the hand speed narrows the gap between the adjacent needle marks.

17. A method of virtually practicing making of a tattoo on skin, the method comprising the steps of:
providing a system, the system simulates tattooing on the skin by a needle-based tattooing machine, the system comprises:
an electronic device having a processor, a memory, and a display, the display includes a touchscreen for receiving inputs from a stylus;
the memory including a set of instructions which, when executed by the processor causes the processor to:
provide an interface on the display, the interface comprises a canvas window and a menu, the menu comprises:
options of type of tattooing needles, and
options for setting a voltage,
receiving, by the system, on the canvas window, an input from the stylus; and
upon receiving the input, creating or manipulating a pattern on an area in contact with the stylus, the pattern corresponds to needle marks made by the needle-based tattooing machine on the skin.

18. The method according to claim 17, wherein the input of the stylus is a stroke made by dragging of the stylus on the canvas window, the processor further:
determine the speed of the stylus while dragging, the speed of the stylus corresponds to a hand speed,
wherein the pattern is further based on the hand speed.

19. The method according to claim 18, wherein the processor further
receive a selection of a needle from the options of the type of tattooing needles, wherein the pattern is based on the needle.

20. The method according to claim 19, wherein the needle is a liner needle, and the pattern is an outline of a tattoo.
